(19) United States
(12) Patent Application Publication
(10) Pub. No.: US 2007/0060098 A1
(43) Pub. Date: Mar. 15, 2007

(54) Radio frequency location determination system and method with wireless mesh sensor networks

(75) Inventor: James William McCoy, Plano, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: Innerwireless, Richardson, TX (US)

(21) Appl. No.: 11/196,228

(22) Filed: Aug. 3, 2005

(51) Int. Cl. H04M 11/04

(52) U.S. Cl. 455/404.2

(57) ABSTRACT

A radio frequency (RF) system and method for determining the location of a wireless node in a wireless mesh sensor network is disclosed. The wireless node can be a wireless terminal, a wireless transceiver, or a wireless transmitter. The wireless network includes a plurality of wireless nodes linked to a digital computer, such as, for example, a server or a location processor, via a communications link. The method comprises deploying a plurality of identifier wireless nodes each at a predetermined location. Node-to-node data for the wireless nodes are generated, the node-to-done data providing information regarding a wireless node's communication with other wireless nodes. The node-to-node data is transmitted to the digital computer where the node-to-node data is processed to generate a map identifying the locations of the wireless nodes.

### CROSS-REFERENCE TO RELATED APPLICATIONS

NA

### STATEMENTS REGARDING FEDERALLY SPONSORED RESEARCH OR DEVELOPMENT

NA

### REFERENCE TO A MICROFICHE APPENDIX

NA

### BACKGROUND OF THE INVENTION

1. Field of the Invention

The invention relates generally to the field of radio frequency (RF) communications. More specifically, the invention relates to a location determination system and method using RF communications with wireless mesh networks and wireless sensor networks.

2. Description of the Related Art

RF technology has been used in many applications such as, for example, determining the location of a wireless terminal, asset tracking, asset monitoring and recovery, and fleet and resource management. The location of a wireless terminal, e.g., a wireless transceiver, may be determined using various methods including range-domain and position-domain methods. The range-domain method uses a number of range related measurements to compute the location of a terminal. Range related measurements include measurements that can be used to determine the actual distance between a transmitter and the terminal. The position-domain method uses knowledge of the position of a base transceiver that is in communication with the terminal to estimate the location of the terminal. The terminal must be within a known limited radius of the base transceiver since the two are in communication.

Currently available RF system and method for determining the location of a wireless terminal are expensive or complicated for many applications such as, for example, residential, commercial, and industrial building automation. Many RF systems use proprietary and complex single purpose hardware and software, proprietary protocols and special purpose RF transponders, known as “tags.” Consequently, these RF systems are expensive.

A typical RF system includes a location processor connected to a plurality of location transceivers. The location processor may be a computer, such as, for example, a Windows PC or a Linux Server. The location processor may be connected to the location transceivers via, for example, a LAN connection. The location transceivers are configured to take measurements and provide the measurements (i.e., data) to the location processor. The location processor typically includes software applications for processing the data. The location processor may be connected to a database to store the computed locations information.

Recent RF systems have attempted to use existing data communications infrastructure and protocols such as, for example, IEEE 802.11 WLAN standards. However since WLAN standards provide a finite maximum communications capacity, any increase in WLAN applications as required by typical RF location systems, increases the load on a limited resource (i.e., communications capacity). WLAN standards also define a minimum communications capacity utilized by each application fully compliant with the standard, creating an overhead burden for each application.

Consequently, attempts to develop an economically viable RF system for location determination using IEEE 802.11 WLAN standards have proven to be difficult. While retail prices of consumer WiFi equipment have fallen, the total cost of an enterprise WLAN remains high. The total cost of an enterprise WLAN includes the cost of WLAN Access Points (APs) to the RF, which is quite expensive. Furthermore, APs are not manufactured to make precise measurements of range or position. The APs must be deployed on a high density to ensure that all tags are in close proximity to the APs if location accuracy is required. For example a location accuracy of 300 sq. ft. will require an AP density of one per 1200 sq.ft., which represents 2 to 3 fold increase beyond the most dense AP deployment guidelines for enterprise WLAN.

Also, the 802.11 is a complex protocol that consumes a relatively large amount electrical power. The 802.11 protocol was originally created as a general purpose communications method for packetized data, but which has been extended to voice and multimedia (streaming audio and video) applications. The 802.11 protocol requires that a chip must evaluate all of the possibilities that the standard allows for each communications message in real time, requiring a high gate count of the chip and consequently high power consumption. Since the tags have limited battery power, the 802.11 protocol is not suitable for applications in conjunction with the tags.

Accordingly, a need exists for an economically viable and less complex RF system and method for determining the location of a wireless terminal. A need exists for a RF system and method that consumes less power and does not require proprietary hardware and software. A need exist for a system and method that is suitable for use in a wide range of applications such as, for example, asset tracking and asset monitoring and recovery.

### BRIEF SUMMARY OF THE INVENTION

The invention is directed to a radio frequency (RF) system and method for determining the location of a wireless node in a wireless mesh network. The wireless node can be a wireless terminal, a wireless transceiver, or a wireless transmitter. The wireless network includes a plurality of wireless nodes linked to a digital computer, such as, for example, a server or a location processor, via a communications link.

The method comprises deploying a plurality of identifier wireless nodes each at a predetermined location. Node-to-node data for the wireless nodes are generated, the node-to-node data providing information regarding a wireless node's communication with other wireless nodes. The node-to-node data is transmitted to the digital computer where the node-to-node data is processed to generate a map identifying the locations of the wireless nodes.

The method further comprises identifying the wireless nodes that are in direct communication with other wireless nodes, transmitting the identity of the wireless nodes in direct communication with other wireless nodes to the digital computer, the identity of the wireless nodes in direct communication with other wireless nodes being a node-to-node data.

The method further comprises measuring the RF signal strength at the wireless nodes, the RF signal strength indicating the strength of the signal received at a particular wireless node from another wireless node, transmitting the measured RF signal strength to the digital computer, the measured RF signal strength being a node-to-node data.

The method further comprises measuring differential time of arrivals of the received signals at the wireless nodes, the differential time of arrival of the received signals indicating the relative propagation time delay of the received signals at a particular wireless node, transmitting the measured differential time of arrivals of the received signals to the digital computer, the measured differential time of arrivals of the received signals being a node-to-node data.

The method further comprises measuring the angle of arrival of the received signals at the wireless nodes, the angle of arrival of the received signals indicating the direction of the received signals, transmitting the measured angle of arrival of the received signals to the digital computer, the measured angle of arrival of the received signals being a node-to-node data.

### BRIEF DESCRIPTION OF THE DRAWINGS

FIG. 1 illustrates a RF location determination system 100 in accordance with one embodiment of the invention.

FIG. 2A shows association lists created by the radio nodes of FIG. 1.

FIG. 2B shows an association table generated from the association lists of FIG. 2B.

FIGS. 3A and 3B shows two topology diagrams generated from the association table of FIG. 2B.

FIG. 4A shows the radio nodes of FIG. 1 and three identifier nodes.

FIG. 4B shows an association table that includes node-to-node data transmitted by the radio nodes.

FIG. 5 illustrates the inclusion of identifier nodes at known locations defining the physical boundaries of the network area.

FIG. 6A shows the association lists identifying nodes in direct communication with other nodes and the respective RF signal strengths.

FIG. 6B shows an association table created from the association list of FIG. 6A.

FIGS. 7A, 7B and 7C illustrate a scenario where there is an insufficient number of identifier nodes.

FIG. 8 illustrates a scenario where there is a sufficient number of identifier nodes representing a statistically significant sampling of the potential communications paths utilized by other nodes.

### DETAILED DESCRIPTION OF THE INVENTION

The invention is a RF location determination system and method with wireless mesh sensor-type networks. Those skilled in the art will recognize that mesh-type sensor networks are used in many forms of communications, control, sensing, and other special purpose wireless systems. Those skilled in the art will also understand that a wireless mesh-type network is any wireless network wherein network members (e.g., wireless terminals, transceivers or wireless nodes) can autonomously determine those other network members with which they can directly communicate, and each member has the capability to communicate with all other network members via message routing and message forwarding techniques. The invention can be used in many applications such as, for example, determining the location of a wireless terminal, asset tracking, asset monitoring and recovery, and fleet and resource management. The wireless terminal may be a wireless transceiver, a transmitter or simply a tag with transmit and optionally receive capability

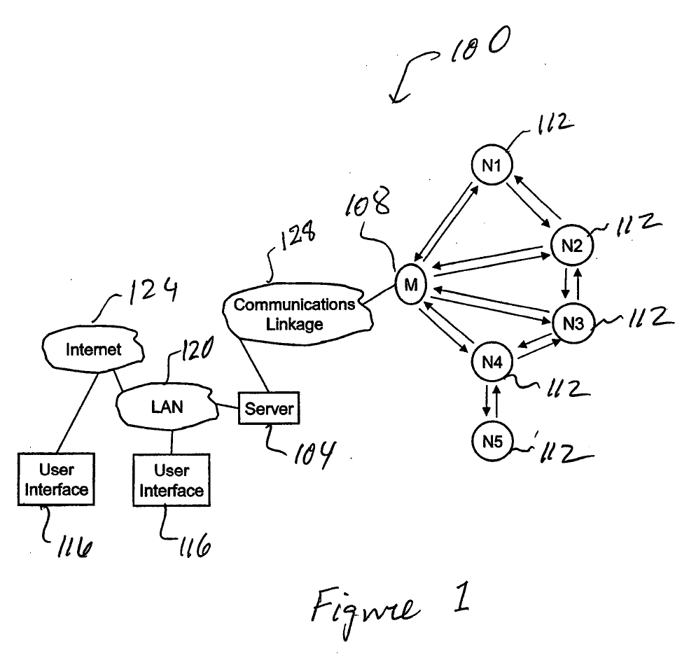

FIG. 1 illustrates a RF location determination system 100 in accordance with one embodiment of the invention. The system 100 includes a server 104 that is in communication with a master node 108 (also designated as M) via, for example, a wireless communications link 128. The server 104 may be a special purpose applications processor, or a location processor, or a general purpose digital computer. The master node M is linked to a plurality of radio nodes (i.e., wireless nodes) 112A-112F (also designated as N1-N5, respectively) via a wireless communications link. In such an embodiment, the server 104 processes data transmitted by the plurality of the wireless nodes to determine the location of the wireless nodes. The master node M is typically placed in a known location.

The radio nodes N1-N5 may each be a typical wireless terminal, i.e., a wireless transceiver. The master node M may be otherwise identical to the radio nodes N1-N5 but may optionally have increased transmit power and increased receive sensitivity. In other words, the master node M may be a high power, increased sensitivity wireless transceiver, while the radio nodes N1-N5 may be low power, low sensitivity wireless transceivers. Thus, the invention can be implemented without a master node.

Referring back to FIG. 1, the server 104 may be linked to one or more user interfaces 116 through a LAN 120. The server 104 may otherwise be linked to the user interfaces 116 through the LAN 120 and the Internet 124. The user interfaces 116 allow users and other application processors to gain access to the server 104.

In one embodiment, the radio nodes N1-N5 communicate with each other and also with the master node M using the IEEE 802.15.4 standard and the ZigBee protocol that runs on top of the 802.15.4 standard. The IEEE 802.15.4 standard allows the implementation of a low-cost, single chip transceiver. Thus, the radio nodes N1-N5 and the master node M can each be implemented on a single chip. The system 100 preferably includes a sufficient multiplicity of radio nodes such that all nodes have at least one communications path, direct or indirect, to the master node M and hence to the server 104.

In operation, the nodes, including the master node, generates node-to-node data. The node-to-node data provides information about a particular node's communication with other nodes. The node-to-node data, for example, may include the identities of all nodes that a particular node is in communication with. The identities of all nodes that a particular node is in communication with may be, for example, included in an association list or some other list or database. Thus, the association list can identify, for a particular node, all other nodes, including the master node, that the particular node is in direct communication. A radio node may also include additional information in its node-to-node data or its association list as will be discussed later.

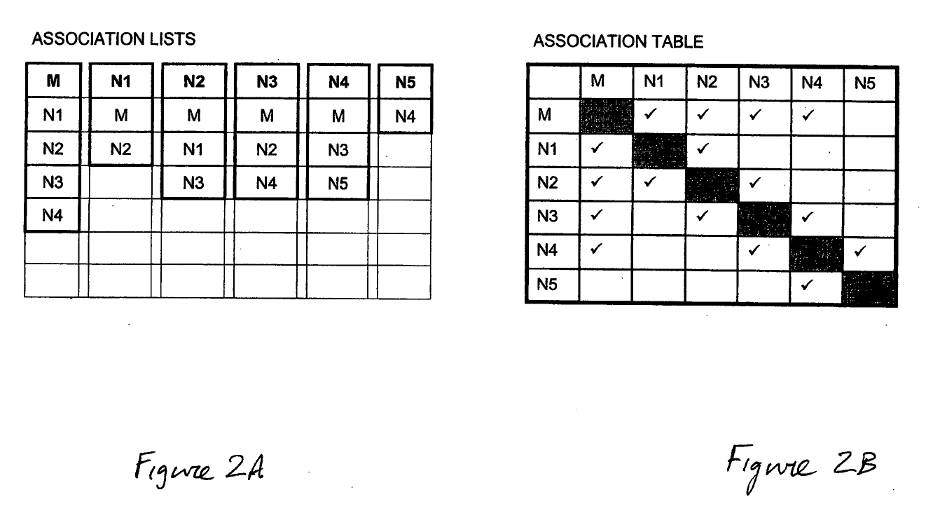

FIG. 2A shows association lists created by the radio nodes N1-N5 including the master node M of FIG. 1. For example, the association list provided by the master node M includes the nodes N1, N2, N3 and N4 since the radio nodes N1-N4 are in direct communication with the master node M. The association list provided by the node N1 includes the nodes M and N2 since the radio node N1 is in direct communication with nodes M and N2 only.

Each node transmits its node-to-node data to the server 104. Referring back to FIG. 1, the node-to-node data from the master node M is transmitted directly over the communication link 128 to the server 104. The node-to-node data from the other nodes N1-N5 are transmitted to the server 104 via the master node M.

In one embodiment, the server 104 combines the association lists into an association table as shown in FIG. 2B. The association table includes node-to-node data. Referring back to FIG. 1, since the master node M is in direct communication with N1, N2, N3, and N4, the association table indicates that M is in direct communication with nodes N1-N4. Since the node N5 is in direct communication with node N4 only, the association table indicates accordingly. As will be understood by those skilled in the art, the node-to-node data may be transmitted by the nodes in other forms.

In one embodiment, the server 104 processes the node-to-node data to generate a topology diagram of the nodes. The server 104, for example may apply well known network management topology methods or tools such as Network Management System (NMS) topology software to the node-to-node data to generate a topology diagram for the nodes. The application of NMS software to the node-to-node connectivity data to form a topology diagram is well understood by those skilled in the art and hence will not be described here. The server 104 may apply other equations or Boolean logic to the node-to-node data to generate a topology diagram as will be understood by those skilled in the art.

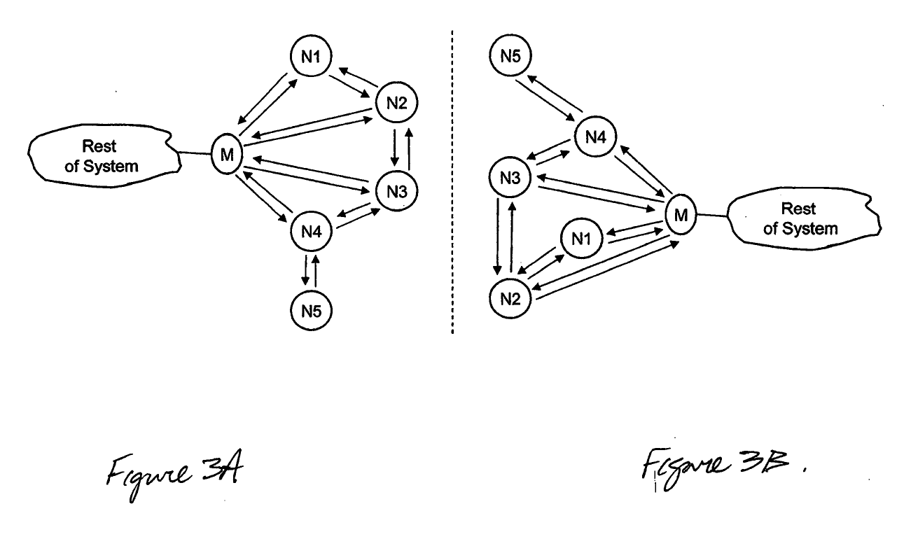

FIGS. 3A and 3B shows two topology diagrams formed using the association table of FIG. 2B. The association table of FIG. 2 provides only limited data that indicates the association among the nodes. The association table does not include other data, such as, for example signal strength of the received signals at the nodes. In consequence, the data in the association table of FIG. 2B is insufficient to form a topology diagram that uniquely identifies the location of the nodes. The limited data in the association table can be used to form two or more topology diagrams corresponding to the association table.

The uniqueness of each node's placement in the topology diagram depends on the uniqueness of the associations. It is well understood by those skilled in the art that as the nodes are spread across larger spaces, or are introduced into partially or wholly confined spaces, the associations become progressively unique (fewer nodes with multiple connections) due to the nature of RF signal propagation. The resulting topology diagram represents the relative placement of the nodes with respect to the master node and to each other. It does not orient the diagram or scale the diagram.

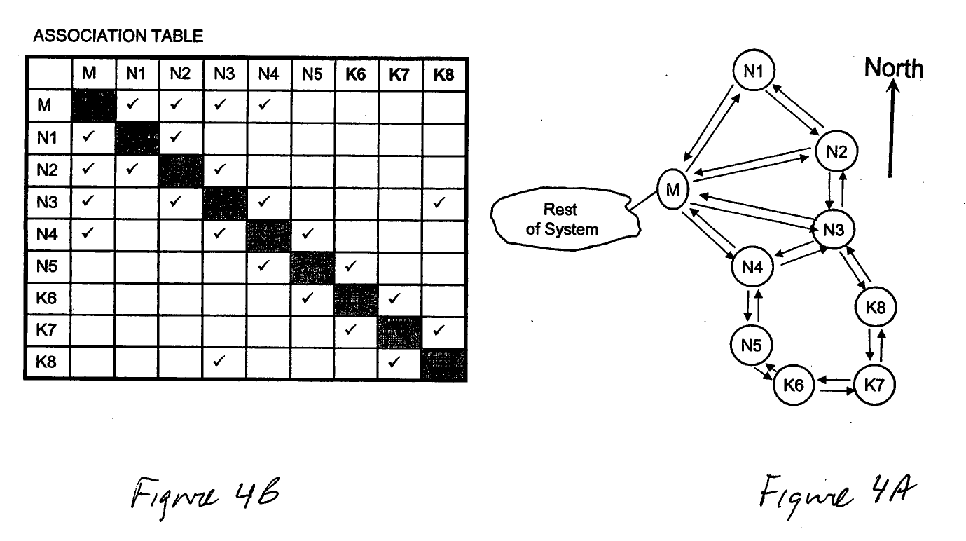

FIG. 4A shows the nodes of FIG. 1 as well as three identifier nodes K6, K7 and K8. The identifier nodes K6, K7 and K8 are each placed at a known location. The three identifier nodes have sufficient spacing among them such that at least two of their association lists are unique.

The inclusion of at least three additional nodes K6, K7, and K8, each at a known location, with sufficient spacing and appropriate geometry between them, such that at least two of their association lists are unique allows the diagram of FIG. 4A to be oriented i.e., North-South and East-West. Orientation is one requirement to transform a diagram into a map. However, clusters of nodes that lack unique association lists may still exist and are not resolvable within the diagram. Thus, in the diagram of FIG. 4A, the cluster of nodes comprising the nodes M, N1 and N2 may be “flipped” without a change in the node-to-node data (or association lists). Thus, in FIG. 4A, the location of the nodes N1 and N2 cannot be uniquely determined. FIG. 4B shows an association table that includes node-to-node data transmitted by the nodes including the master node and the identifier nodes. Thus, if the nodes provided limited information in the node-to-node data as provided in FIG. 4B, locations of one or more nodes in the network may not be uniquely determined, i.e., there may be two or more solutions.

In order to determine locations of the nodes in a network, additional information must be provided in the node-to-node data. In one embodiment of the invention, the nodes provide the following information in the node-to-node data: (1) identities of the nodes that a particular node is in communication with; (2) RF signal strength received at the nodes; (3) location of identifier nodes (i.e., nodes at known locations). In one embodiment, the nodes provide the identities of all nodes that each node is in communication with. The nodes also provide the RF signal strength of received signals. The RF signal strength indicates the strength of the signal that a node receives from another node. A plurality of identifier nodes also provide their location information. The identifier nodes are placed at locations that define the physical boundaries of the network area or the map.

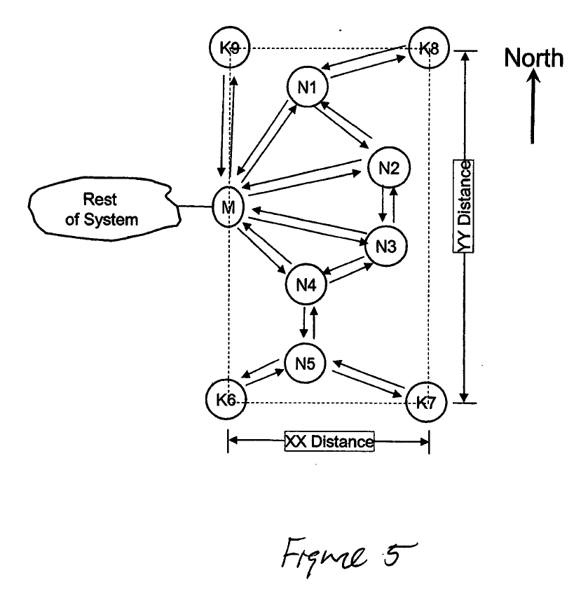

The inclusion of identifier nodes at known locations defining the physical boundaries of the network area may be used to constrain the placement of all other nodes as shown in FIG. 5. The physical boundaries or physical extent is a requirement to transform a topology diagram into a map, but it is not sufficient to uniquely locate the nodes in the map.

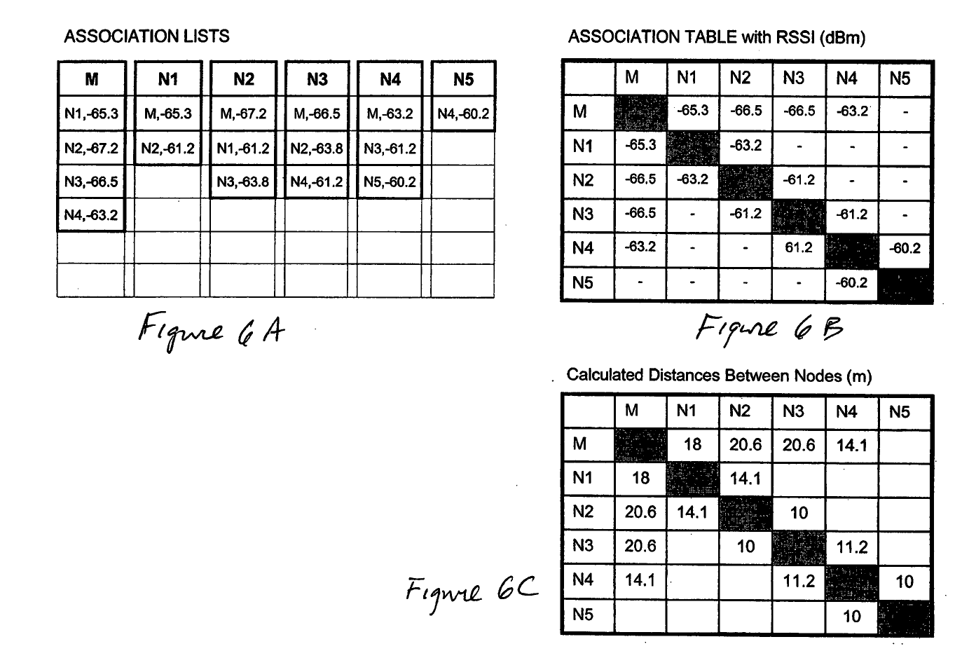

The inclusion of RF signal strength values in each node's node-to-node data (or association list) allows proportional distances between nodes to be calculated by the server. FIG. 6A shows node-to-node data (or association lists) that includes RF signal strength of the received signals at the nodes. For example, in FIG. 6A, the association list of the master node M identifies the nodes that the master node is in direct communication with and the respective RF signal strength. Accordingly, the master node M is in direct communication with the nodes N1, N2, N3 and N4 and have a corresponding RF signal strength of −65.3, −67.2, −66.5 and −63.2 dBm, respectively.

An association list shown in FIG. 6A is used to generate an association table at the server. FIG. 6B shows the association table created from the association list of FIG. 6A. Next, the distances between the nodes are calculated using a well known equation for RF signal path losses:
Distance=(300*10 exp(−0.05*RSSI))/4*pi*f;
where pi=3.141; RSSI is the RF signal strength in dBm; f is the frequency of the signal in MHz; and the resulting distance is in meters.

The calculated distances, in meters, are shown in FIG. 6C. In the examples of FIGS. 6A-6C, the transmitted signal is assumed to have a strength of 1 mw, transmit and receive antenna gains are assumed to be unity, the frequency is expressed in units of MHz, and RF signal strength is expressed in units of dBm.

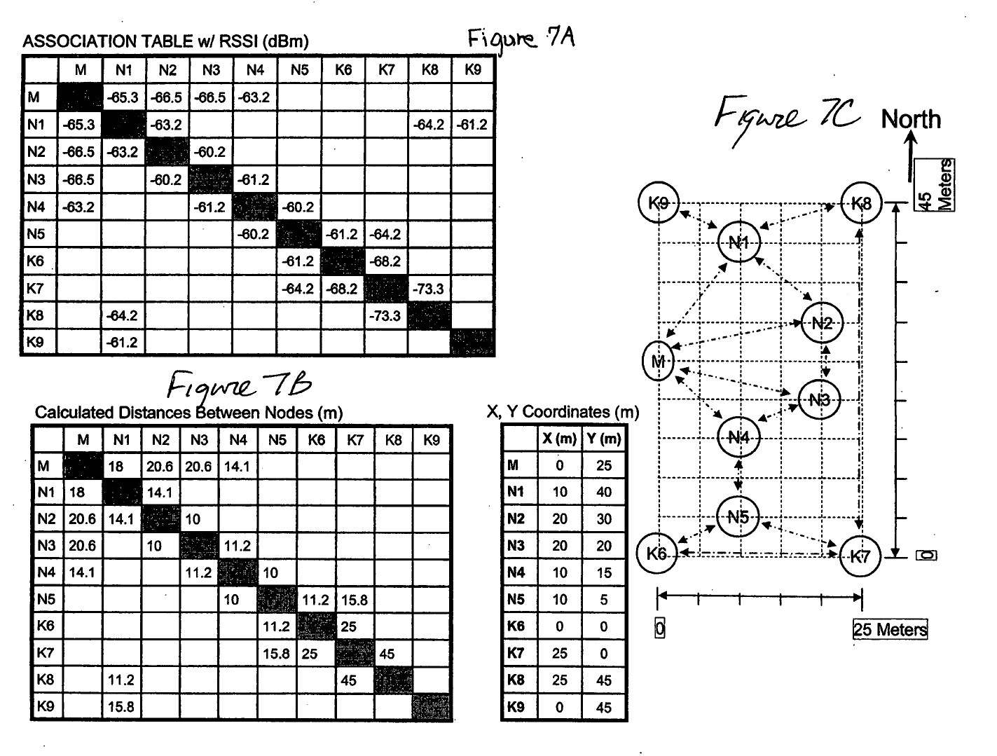

FIGS. 7A, 7B and 7C illustrate a scenario where there is an insufficient number of identifier nodes. FIG. 7A shows an association table generated from node-to-node data. FIG. 7B shows the calculated distances between the nodes, and FIG. 7C shows the resulting map. If there are insufficient numbers of identifier nodes at known locations defining the physical boundaries of the diagram, it may not be possible to determine a unique location for each node. The inclusion of RF signal strength values in the association table allows proportional distances between nodes to be calculated, allowing a physical scale to be assigned to the diagram, and the placement of all nodes to be constrained as shown in FIG. 7C. A map can be created since orientation, physical extent, proportionality, and physical scale are all present. The map of FIG. 7C generated from the association table of FIG. 7A assumes that all nodes are present within the defined area, but the map cannot definitely determine the location of each node.

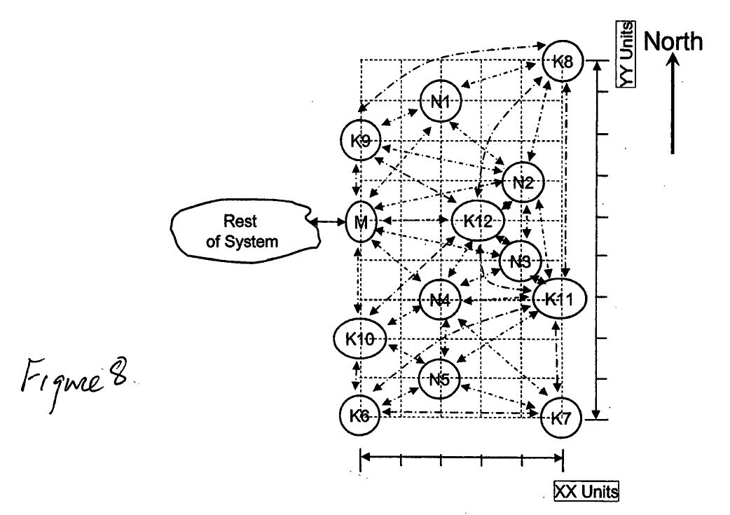

However, when a sufficient number of identifier nodes representing a statistically significant sampling of the potential communications paths utilized by other nodes are included in addition to the RF signal strengths in the node-to-node data, the nodes can be precisely placed relative to each other and in absolute locations on the map as shown in FIG. 8. Those skilled in the art recognize that identifier nodes are used to bound the physical extent of the area and to provide localized calibrations for the RF signal parameter measurements of the wireless nodes to be located, based on the identifier-to-identifier measurements taken over similar paths. Thus, in accordance with one embodiment of the invention, in order to determine the location of the nodes in a map, the RF signal strength and a sufficient number of identifier nodes are required in the node-to-node data. Since a triangle may be described in several ways: (1) the length of each of the three sides; (2) each of the three interior angles formed at the vertices; (3) the length of two sides along with the interior angle at their common vertex, and (4) the length of one side along with the two interior angles at the vertices at each end of the one side, the RF signal strength measurements can be used to determine the location of the nodes as will be understood by those skilled in the art.

When sufficient number of known nodes, i.e., identifier nodes are included at locations throughout the extent of the map, then optimal statistical estimation techniques are used to weight the measurements associated with the known nodes such that any errors in the calculated locations of the unknown nodes are constrained. It is well known by those skilled in the art that optimal estimation techniques require both measurements, i.e. RF signal strength and or other RF signal propagation parameters, and knowledge of the quality (variability) of those measurements. Hence, those skilled in the art recognize the importance of constraining the contributory sources to measurement-to-measurement and unit-to-unit variations in all measured parameters. Representative contributory sources to measurement variation include wireless node transmitter output levels, transmit antenna pattern spatial variation, receiver antenna pattern spatial variation, receiver signal strength circuitry calibration accuracy, other receiver signal parameter measurement circuitry calibration accuracy, and unknown/un-modeled changes in the propagation path itself such as persons and or objects moving between nodes while the measurements are taken.

In one embodiment, the server 104 is configured and the master node M is deployed. A communication link 128 is established between the server and the master node M. Next, the radio nodes use pre-established communication protocol to discover each other, i.e., identify the nodes that each node can directly communicate with. The radio nodes that generate node-to-node data (e.g., association list) including identity of the nodes that they are in communication with and RF signal strength of the received signals as discussed before. The node-to-node data is updated whenever a new radio node enters the network. Upon receipt of a command from the server or upon the radio nodes' own initiation, each radio node transmits its node-to-node data through the network to the server. In one embodiment, the server processes the node-to-node data to create a table or a database that contains all logical associations of the radio nodes within the wireless network. The server processes the table to generate a topology of interconnections between the radio nodes.

In one embodiment, a node may transfer its node-to-node data, with or without RF signal strength values, to the server for processing. The node may transfer the node-to-node data in response to a command from the server (scheduled or on-demand), or the transfer may be asynchronously initiated by the node at a server assigned rate, or upon an autonomous determination that its data has changed (e.g., change in RF signal strength or change in the identities of the nodes that a node is in communication with). A node may be programmed by the server to change its communications behavior with the server via messages from the server. A node may transfer its entire association list to the server for processing, or the transfer may be limited to the data values that have changed subsequent to the last transfer.

When a sufficient number of identifier nodes at known locations are present in the network, the transfer of the node-to-node data, with or without RSSI values, may be limited only to either the identifier nodes or the unknown nodes with the other group only transferring their preferred communications path association, with or without RSSI value, thereby allowing full functionality nodes and reduced functionality nodes to coexist within a common network. It is well understood by those skilled in the art that the logical associations and the RF signal propagation parameters between any two nodes are fully reciprocal and hence the redundant data need not be transmitted. It is also well understood by those skilled in the art that the precise measurement of RF signal propagation parameters adds to the complexity, power consumption, and cost of the node and hence the desire for reduced functionality nodes.

Each node may transfer its node-to-node data to the server encapsulated in a general purpose message (e.g., a network management message), in a dedicated message for location processing, or as appended data in a message whose primary purpose is not related to location (e.g., in a wireless sensor network wherein the primary message function might be reporting temperature or vibration data).

In cases of larger maps and high node densities a server algorithm may partition the map, and associated groups of nodes, for computational efficiency. In cases of a large network area, the network may be implemented with a multiplicity of master nodes, each master node facilitating a portion of the total network. The multiplicity of master nodes may, but is not required to, correspond with a multiplicity of servers.

In cases with non-contiguous map areas, i.e., a multi-building campus or multiple floors within a building, the network may be implemented with a multiplicity of master nodes with one master per non-contiguous area.

In one embodiment of the invention, the use of RF signal strength values may be replaced with, or augmented by, the use of Differential Time of Arrival (DTOA) measurements. The DTOA measurements are then converted to distance using equations that are well known to those skilled in the art. Consider, for example that DTOA is measured in units of nano-seconds, that the velocity of propagation is the speed of light (3×10⁸ meters/sec), and that distance is to be expressed in units of meters. Then, Distance=0.3*DTOA. Since both RF signal strengths and DTOA measurements are converted to distance, any combination of measurements can be used. When RF signal strength and DTOA measurements are available, both measurements can be utilized and the results of each can be optimally combined using least mean square (LMS), or Kalman, estimators to minimize any errors in the final calculated locations.

In one embodiment of the invention, the use of RF signal strength values may be replaced with, or augmented by, the use of Angle of Arrival (AOA) measurements. The use of AOA takes advantage of planar geometric relationships. Since a triangle may be described in several ways: (1) the length of each of the three sides; (2) each of the three interior angles formed at the vertices; (3) the length of two sides along with the interior angle at their common vertex, and (4) the length of one side along with the two interior angles at the vertices at each end of the one side, the AOA measurements can be used to determine the location of the nodes.

In one embodiment, the use of RF signal strength values may be replaced with, or augmented by the use of DTOA and AOA measurements. When all three measurements are available the resulting optimal combination will produce the minimum possible location errors since three independent physical phenomena are used for the measurements.

As discussed before, in one embodiment, the invention utilizes the IEEE 802.15.4 standard and the ZigBee protocol that run on top of the 802.15.4 standard. The IEEE 802.15.4 standard allows maximum information throughput and minimal overhead. The IEEE 802.15.4 standard further allows the wireless nodes to self organize themselves into a required wireless network topology as devices are added to, or removed from, the network.

In one embodiment, the server 104 may contain software to associate tags with assets (e.g., items, or persons) to which the tags are assigned or attached to. The server may also contain software to support text and graphical interactions with users. The server may also contain software to support processor-to-processor interface with other third party software that utilizes location information to perform other functions. The identifier nodes are deployed in sufficient density and with appropriate spatial interrelationships to allow multiple observations of the tags throughout an area of interest.

While certain exemplary embodiments have been described in detail and shown in the accompanying drawings, it is to be understood that such embodiments are merely preferred and only illustrative of and not restrictive on the broad invention. Other and further embodiments of the invention may be devised without departing from the basic scope thereof, which is determined by the claims that follow. By way of example, and not limitation, the specific components utilized may be replaced by known equivalents or other arrangements of components which function similarly and provide substantially the same result.

We claim:

1. A method for determining the location of a wireless node in a wireless mesh sensor network, the network comprising a plurality of wireless nodes linked to a digital computer via a communications link, the wireless nodes being wireless terminals, the method comprising:
deploying a plurality of identifier wireless nodes each at a predetermined location;
generating node-to-node data for the wireless nodes, the node-to-node data providing information regarding a wireless node's communication with other wireless nodes;
transmitting the node-to-node data to the digital computer;
processing the node-to-node data;
generating a map of the wireless nodes identifying the locations of the wireless nodes.

2. The method of claim 1 further comprising applying network management system topology method to the node-to-node data to generate the map of the wireless nodes.

3. The method of claim 1 further comprising:
identifying the wireless nodes that are in direct communication with other wireless nodes;
transmitting the identity of the wireless nodes in direct communication with other wireless nodes to the digital computer, the identity of the wireless nodes in direct communication with other wireless nodes being a node-to-node data.

4. The method of claim 1 further comprising:
measuring the RF signal strength at the wireless nodes, the RF signal strength indicating the strength of the signal received at a particular wireless node from another wireless node;
transmitting the measured RF signal strength to the digital computer, the measured RF signal strength being a node-to-node data.

5. The method of claim 1 further comprising:
measuring differential time of arrivals of the received signals at the wireless nodes, the differential time of arrival of the received signals indicating the relative propagation time delay of the received signals at a particular wireless node;
transmitting the measured differential time of arrivals of the received signals to the digital computer, the measured differential time of arrivals of the received signals being a node-to-node data.

6. The method of claim 1 further comprising:
measuring the angle of arrival of the received signals at the wireless nodes, the angle of arrival of the received signals indicating the direction of the received signals;
transmitting the measured angle of arrival of the received signals to the digital computer, the measured angle of arrival of the received signals being a node-to-node data.

7. The method of claim 1 wherein the wireless nodes includes wireless transceivers.

8. The method of claim 1 wherein the wireless nodes includes wireless transmitters.

9. The method of claim 1 further comprising generating an association lists at the wireless nodes, the association lists including the node-to-node data;
transmitting the association lists to the digital computer.

10. The method of claim 1 wherein at least three identifier wireless nodes are deployed each at the predetermined location, the identifier nodes being wireless terminals.

11. The method of claim 1 wherein the identifier nodes are deployed at predetermined locations at the physical boundaries of the map.

12. The method of claim 11 wherein the identifier wireless nodes are deployed in a selected manner with minimum distance among the identifier wireless nodes and a geometry such that at least two of the identifier wireless nodes have unique node-to-node data.

13. The method of claim 9 further comprising combining the association lists at the digital computer to generate an association table, the association table including node-to-node data regarding each node's communication in respect of other nodes

14. The method of claim 1 wherein the digital computer is a server.

15. The method of claim 1 wherein the digital computer is a location processor.

16. The method of claim 1 further comprising transmitting the node-to-node data to the digital computer in response to a command from the digital computer.

17. The method of claim 1 further comprising transmitting the node-to-node data to the digital computer at a predetermined time interval.

18. The method of claim 1 further comprising transmitting the node-to-node data to the digital computer when a wireless node detects a change in the node-to-node data.

19. The method of claim 1 further comprising transmitting a partial node-to-node data that includes up-dated data.

20. The method of claim 1 further comprising transmitting the node-to-node data to the digital computer encapsulated in a general purpose message.

21. The method of claim 1 further comprising transmitting the node-to-node data to the digital computer as appended data in another message

22. The method of claim 1 wherein at least one of the wireless nodes operate as a master node.

23. The method of claim 22 wherein a plurality of master nodes are deployed in the network, each master node being assigned to a section of the overall area of the network.

24. The method of claim 22 wherein the wireless nodes transmits the node-to-node data to the digital computer via the master node.

25. The method of claim 22 wherein the master node is in direct communication with the digital computer.

26. The method of claim 22 wherein the master node is a wireless transceiver having higher transmit power and increased receive sensitivity than other wireless nodes.

27. A radio frequency (RF) location determination system for determining the location of a wireless node in a wireless mesh sensor network, comprising:
a plurality of wireless nodes, the wireless nodes being wireless terminals;
a digital computer linked to the wireless nodes via a communications link;
a plurality of identifier wireless nodes each at a predetermined location;
node-to-node data for the wireless nodes, the node-to-node data providing information regarding a wireless node's communication with other nodes;
a plurality of transmitters for transmitting the node-to-node data to the digital computer, wherein the node-to-node data is processed by the digital computer to generate a map of the wireless nodes identifying the locations of the wireless nodes.

28. The RF location determination system of claim 27 wherein the node-to-node data includes identities of the wireless nodes in direct communication with other wireless nodes, and wherein the identities of the wireless nodes in direct communication with other wireless nodes are transmitted to the digital computer.

29. The RF location determination system of claim 27 wherein the node-to-node data includes RF signal strength at the wireless nodes, the RF signal strength indicating the strength of the signal received at a particular wireless node from another wireless node, and wherein the RF signal strength is transmitted to the digital computer.

30. The RF location determination system of claim 27 wherein the node-to-node data includes differential time of arrivals of the received signals at the wireless nodes, the differential time of arrival of the received signals indicating the relative propagation time delay of the received signals at a particular wireless node, and wherein the differential time of arrivals of the received signals are transmitted to the digital computer.

31. The RF location determination system of claim 27 wherein the node-to-node data includes the angle of arrival of the received signals at the wireless nodes, the angle of arrival of the received signals indicating the direction of the received signals, and wherein the angle of arrival of the received signals is transmitted to the digital computer.

32. The RF location determination system of claim 27 wherein the wireless nodes include at least one wireless transceiver.

33. The RF location determination system of claim 27 wherein the wireless nodes include at least one wireless transmitter.

34. The RF location determination system of claim 27 further comprising at least one association list including the node-to-node data, wherein the association list is generated by the wireless nodes.

35. The RF location determination system of claim 27 further comprising at least three identifier wireless nodes deployed each at the predetermined location, the identifier nodes being wireless terminals.

36. The RF location determination system of claim 27 wherein the digital computer is a server.

37. The RF location determination system of claim 27 wherein the digital computer is a location processor.

38. The RF location determination system of claim 27 wherein at least one of the wireless nodes operate as a master node.

39. The RF location determination system of claim 38 further comprising a plurality of master nodes deployed in the network, each master node being assigned to a section of the overall area of the network.

40. The RF location determination system of claim 38 wherein the wireless nodes transmits the node-to-node data to the digital computer via the master node.

41. The RF location determination system of claim 38 wherein the master node is in direct communication with the digital computer.

42. The RF location determination system of claim 38 wherein the master node is a wireless transceiver having higher transmit power and increased receive sensitivity than other wireless nodes.

43. The method of claim 1 wherein the radio nodes communicate with each other using IEEE 802.15.4 communication protocol standard.

44. The method of claim 1 wherein the radio nodes communicate with each other using IEEE 802.15.4 communication protocol standard and the Zigbee protocol standard.

45. The system of claim 27 wherein the radio nodes communicate with each other using IEEE 802.15.4 communication protocol standard.

46. The system of claim 27 wherein the radio nodes communicate with each other using IEEE 802.15.4 communication protocol standard and the Zigbee protocol standard.
